(19) United States
(12) Patent Application Publication
(10) Pub. No.: US 2011/0091321 A1
(43) Pub. Date: Apr. 21, 2011

(54) SYSTEMS AND METHODS FOR MONITORING WIND TURBINE OPERATION

(76) Inventors: Myles L. Baker, Long Beach, CA (US); Cory P. Arendt, Huntington Beach, CA (US); Andrew Dahlin, Long Beach, CA (US); Mehrdad Mostoufi, Long Beach, CA (US); Kevin M. Roughen, Manhattan Beach, CA (US)

(21) Appl. No.: 12/904,071

(22) Filed: Oct. 13, 2010

Related U.S. Application Data
(60) Provisional application No. 61/251,229, filed on Oct. 13, 2009.
(60) Provisional application No. 61/384,675, filed on Sep. 20, 2010.

(51) Int. Cl. F03D 7/00; F03D 11/00; G01L 1/22

(52) U.S. Cl. 416/1; 416/61; 702/42

(57) ABSTRACT

Systems and methods for monitoring wind turbine operation are disclosed. A method in accordance with one embodiment includes processing sensor data received from at least one strain gauge located on a wind turbine shaft, with a processor located on the wind turbine shaft. In particular embodiments, the method can further include providing power for the at least one strain gauge and the processor via a non-contact link between a first component located on the wind turbine shaft and second component off the wind turbine shaft. In further particular embodiments, the method can still further include receiving data from the processor corresponding to bending moments at the wind turbine shaft, and automatically identifying load remediation solutions for the wind turbine, based at least in part on the data received from the processor.

### CROSS-REFERENCE TO RELATED APPLICATIONS

The present application claims priority to the following U.S. Provisional Patent Applications, both of which are incorporated by reference herein in their entireties: 61/251,229, filed Oct. 13, 2009, and 61/384,675, filed Sep. 20, 2010.

### TECHNICAL FIELD

Aspects of the present disclosure are directed to systems and methods for monitoring wind turbine operation, for example, by measuring and analyzing the strain and bending moments on a wind turbine shaft.

### BACKGROUND

As fossil fuels become scarcer and more expensive to extract and process, energy producers and users are becoming increasingly interested in other forms of energy. One such energy form that has recently seen a resurgence is wind energy. Wind energy is typically harvested by placing a multitude of wind turbines in geographical areas that tend to experience steady, moderate winds. Modern wind turbines typically include an electric generator connected to one or more wind-driven turbine blades, which rotate about a vertical axis or a horizontal axis.

One problem encountered with existing wind turbine systems is that certain system components can wear out prematurely, which creates the need to repair or replace the components. As wind turbines may often be located in remote areas, and the components may be located high above the ground, repairing or replacing the components can be time consuming, expensive, and inconvenient. Accordingly, existing wind turbine systems are typically outfitted with one or more monitors that track wind turbine operating parameters and can identify and/or predict faults or other operational defects. However, a drawback associated with conventional monitoring systems is that they are typically expensive to purchase, install, and operate. Another drawback with existing monitoring systems is that the results produced by the monitoring systems may be ambiguous and/or otherwise difficult to interpret and act upon. Accordingly, there remains a need in the wind turbine industry for improved monitoring systems and methods.

### BRIEF DESCRIPTION OF THE DRAWINGS

FIG. 1 is a partially schematic, isometric illustration of a wind turbine system configured in accordance with an embodiment of the disclosure.

FIG. 2 is a partially schematic, exploded isometric illustration of further aspects of a wind turbine monitoring system configured in accordance with an embodiment of the disclosure.

FIGS. 3A and 3B are partially schematic illustrations of a power transmitter configured to transmit power to a shaft-mounted portion of a monitoring system in accordance with an embodiment of the disclosure.

FIG. 4 is a flow diagram illustrating a process for handling and analyzing wind turbine monitoring data in accordance with an embodiment of the disclosure.

FIG. 5 is a flow diagram illustrating a process for diagnosing symptoms associated with abnormal wind turbine loads, and identifying solutions directed toward reducing the loads.

FIGS. 6A-6C are flow diagrams illustrating processes for reducing data in accordance with an embodiment of the disclosure.

FIG. 7 is a schematic illustration of a representative user interface configured in accordance with an embodiment of the disclosure.

FIGS. 8A-8I are graphical illustrations of results obtained using systems configured in accordance with embodiments of the present disclosure.

### DETAILED DESCRIPTION

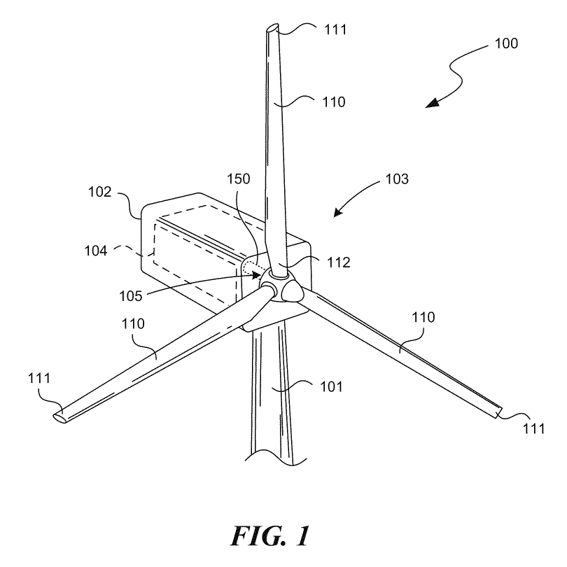

The present disclosure is directed generally to systems and methods for monitoring and responding to wind turbine operational loads. Several details describing structures or processes that are well-known and often associated with such systems and methods are not set forth in the following description to avoid unnecessarily obscuring various embodiments of the disclosure. Moreover, although the following disclosure sets forth several embodiments, several other embodiments can have different configurations, components and/or steps than those described in this section. In particular, other embodiments may have additional elements and/or may lack one or more of the elements described below with reference to FIGS. 1-8I.

Many embodiments of the disclosure described below may take the form of computer-executable instructions, including routines executed by a programmable, special-purpose computer. Those skilled in the relevant art will appreciate that embodiments of the disclosure can be practiced on computer systems other than those shown and described below. Aspects of the disclosure can be embodied in a special-purpose computer or data processor that is specifically programmed, configured or constructed to perform one or more of the computer-executable instructions described below. Accordingly, the terms “computer” and “controller” as generally used herein refer to any appropriately configured data processor and can include Internet appliances and hand-held devices, including palm-top computers, wearable computers, cellular or mobile phones, multi-processor systems, processor-based or programmable consumer electronics, network computers, minicomputers and the like. Information handled by these computers can be presented at any suitable display medium, including a CRT display or an LCD.

Aspects of the disclosure can also be practiced in distributed environments, where tasks or modules are performed by remote processing devices that are linked through a communications network. In a distributed computing environment, program modules or subroutines may be located in local and remote memory storage devices. Aspects of the disclosure described below may be stored or distributed on computer-readable media, including magnetic or optically readable or removable computer disks, as well as distributed electronically over networks. In particular embodiments, instructions and/or other aspects of the disclosure are carried by or included in data structures and transmissions.

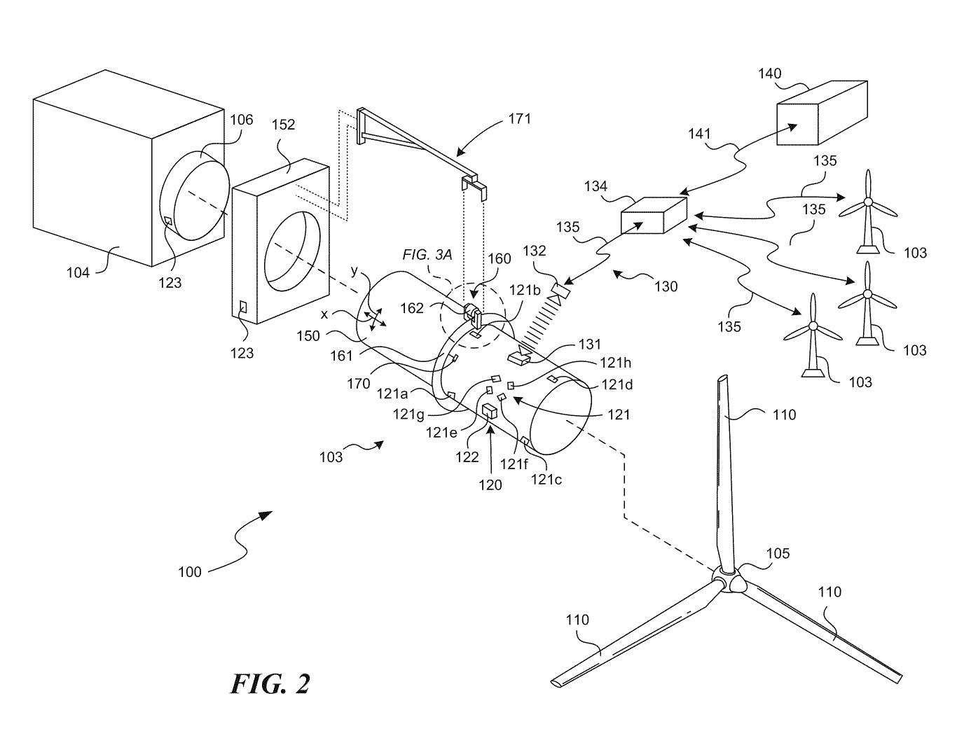

FIG. 1 is a partially schematic, isometric illustration of an overall system 100 that includes a wind turbine 103 having blades 110. The wind turbine 103 includes a tower 101 (a portion of which is shown in FIG. 1), a housing or nacelle 102 carried at the top of the tower 101, and a generator 104 positioned within the housing 102. The generator 104 is connected to a shaft 150 having a hub 105 that projects outside the housing 102. The blades 110 each include a hub attachment portion 112 at which the blades 110 are connected to the hub 105, and a tip 111 positioned radially or longitudinally outwardly from the hub 105. In an embodiment shown in FIG. 1, the wind turbine 103 includes three blades connected to a horizontally-oriented shaft 150. Accordingly, each blade 110 is subjected to cyclically varying loads as it rotates between the 12:00, 3:00, 6:00 and 9:00 positions, because the effect of gravity is different at each position. In other embodiments, the wind turbine 103 can include other numbers of blades connected to a horizontally oriented shaft 150, or the wind turbine 103 can have a shaft with a vertical or other orientation. In any of these embodiments, the shaft 150 and other components of the wind turbine 103 may be subjected to conditions that tend to increase component wear and/or fatigue, and/or tend to reduce overall system performance. Aspects of the present disclosure described further below with reference to FIGS. 2-8I are directed to reducing the impact of such conditions.

FIG. 2 is a partially schematic, partially exploded enlarged illustration of a portion of the wind turbine 103, illustrating additional components that monitor aspects of the wind turbine operation, and can provide information directed to correcting abnormalities should they arise. For purposes of illustration, many of the components shown in FIG. 2 are not drawn to scale. In general terms, the system 100 include multiple sensors 120 that direct sensor signals to a data acquisition/transmission system 130 via one or more communication links. As the information is transmitted, it may also be processed or partially processed. The information is transmitted to a data monitoring/analysis system 140 that further reduces the data, analyzes the data, and provides a user-friendly output to aid the wind turbine operator in identifying and correcting abnormal conditions at the wind turbine 103.

The sensors 120 can be configured to monitor one or more of several basic parameters and/or characteristics associated with the operation of the wind turbine 103. For example, in a particular embodiment, the sensors 120 can include multiple strain gauges 121 (eight are illustrated as strain gauges 121a-121h), one or more accelerometers 122 and one or more temperature sensors 123. One purpose of many of the foregoing sensors is to identify conditions at the shaft 150. The shaft 150 can provide a convenient, single-point component that responds to abnormal loads encountered by other components (e.g., the blades 110) and can transmit the loads to other system components that may be damaged or suffer performance degradations as a result of the transmission (e.g., components of or associated with the generator 104). Aspects of the present disclosure that focus on monitoring the shaft 150 can be relatively simple and cost effective to manufacture and deploy, and can be less susceptible to degradation and/or other failure modes than are existing systems.

In a particular embodiment, the shaft 150 is coupled to a gear box 106 that is in turn coupled to the generator 104. A main bearing 152 supports the shaft 150 between the gear box 106 and the hub 105. Disturbances in the operation of the shaft 150 can result from disturbances to the blades 110, and can be transmitted to the gear box 106 where they can damage the internal components of the gear box 106. Accordingly, the sensors 120 can be positioned between the main bearing 152 and the hub 105 to identify the abnormal loads as they are transmitted via the shaft 150. In particular example, the strain gauges 121 can include four strain gauges 121a, 121b, 121c, 121d positioned 90° apart from each other around the shaft circumference, and at spaced apart axial locations on the shaft 150 to measure strain in the X and Y directions. The measured strain is then used to determine bending moments. An additional four strain gauges 121e-121h can be oriented at 45° angles relative to the major axis of the shaft 150 (e.g., in a bridge arrangement) to measure torsion on the shaft 150. In particular embodiments, the shaft 150 can be outfitted with additional strain gauges. In other embodiments, the number of strain gauges 121 can be reduced. For example, one or more strain gauges can be positioned to provide bending moment and torsion data. In a particular embodiment, three strain gauges and a single-axis accelerometer can be used to determine the axial force and two bending moments on the shaft 150. An advantage of this arrangement is that it is simpler than one that includes more sensors. Conversely, more sensors provide for more robust data and a level of redundancy that can be important due to the relative inaccessibility of the turbine shaft 150.

The sensors 120 can also include a bi-axial accelerometer 122 positioned to measure acceleration in both the X and Y directions. The accelerometer 122 can indicate the force of gravity on the components of the wind turbine 103. In particular, the accelerometers 122 can be used to determine when each of the blades 110 is at a particular azimuthal position. The temperature sensor(s) 123 can be located at any position suitable for measuring local temperature conditions. For example, a temperature sensor 123 can be located off the shaft 150 at the gearbox 106 to measure the gear box temperature, and/or at the main bearing 152 to measure bearing temperature.

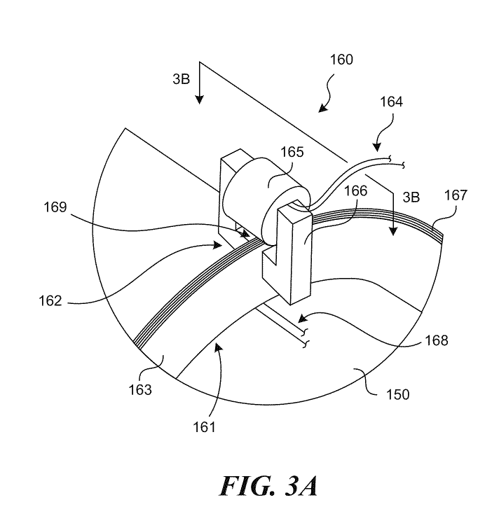

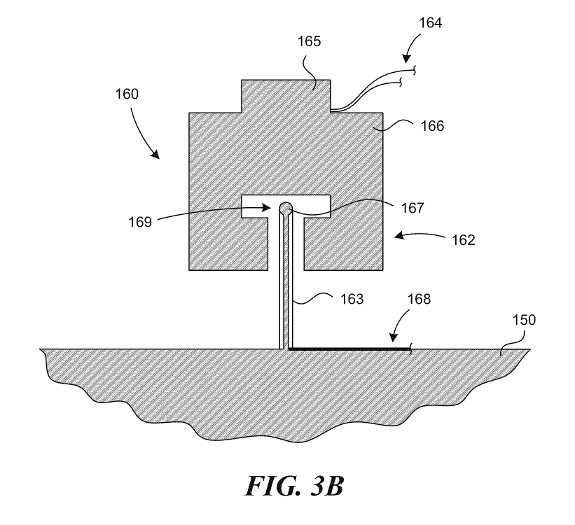

The system 100 can include a first or shaft processor 131 carried by the shaft 150 and positioned to receive signals from the sensors 120 that are mounted to the shaft 150. The sensor signals can be transmitted to the first processor 131 via wires, not shown in FIG. 2. The first processor 131 can process or at least partially process the raw data received from the sensors 120 to reduce the bandwidth required to transmit the data away from the shaft 150. For example, the raw strain gauge measurements can be converted to bending moment and torsion values. In other embodiments, the raw signals from the sensors (e.g., voltages) can be converted to other engineering-unit values that correspond more directly to loads and/or wear on system components. These data can be transmitted wirelessly from the rotating first processor 131 to a second or nacelle processor 132 that is carried by and is fixed relative to the nacelle 102 (FIG. 1). The wireless link can include an RF, ZigBee, Bluetooth, WiFi, RFID, or other suitable link. The power required by the shaft-mounted sensors 120 and the first processor 131 can be provided via a power transmitter 160. In a particular embodiment, the power transmitter 160 can include a transformer with a first or shaft portion 161 inductively coupled to a second or nacelle portion 162. The first portion 161 can include multiple conductive windings positioned around the circumference of the shaft 150, and supported by one or more (e.g., four) legs 170. The second portion 162 can include a generally C-shaped portion that directs electrical power through an electromagnetic field to the first portion 161 as the shaft 150 rotates relative to the nacelle 102. The second portion 162 can be supported in place by a rod 171 carried by the gearbox 106. Further aspects of a particular design for the power transmitter 160 are described below with reference to FIGS. 3A-3B.

Information transmitted from the first processor 131 to the second processor 132 can be further processed at the second processor 132. The level of processing performed by each of the first and second processors 131, 132 can be selected in a manner that best utilizes the available bandwidth and processing capabilities of these components. For example, the data can be compressed by the first processor, and/or the strain measurements can be collected over a period of time and reduced to bending moments and/or axial loads. In a particular embodiment, the data received from the strain gauges can be in the form of sinusoidally varying strain values, and the first processor 131 can pick out only the “peaks” and “valleys” of the waves, and transmit this information (as a function of time) to the second processor 132. The second processor 132 can reconstruct the sine wave pattern if necessary to further process the data. The data are then transmitted from the nacelle 102 to the data monitoring/analysis system 140 via a suitable transmission mode (e.g., wired, wireless, satellite, mesh network, wireless mesh network, Ethernet or other mode). The system can use existing protocols, e.g., supervisory control and data acquisition (SCADA) protocols. In a particular embodiment, this transmission can be conducted via a data collector 134. Accordingly, data can be transmitted to the collector 134 via a nacelle/collector link 135, and then transmitted to the data monitoring/analysis system 140 via a collector/analysis link 141. In a particular embodiment, the data collector 134 can include a computer system located at a wind farm, so as to receive information from multiple wind turbines 103 via corresponding nacelle/collector links 135. The data transmitted from each wind turbine 103 can include data received from the shaft-mounted sensors 120, as well as other data, e.g., clock data, RPM data, temperature data and/or wind speed data. The data monitoring/analysis system can be located remote from the wind farm, e.g., at a central location so as to make use of information received from multiple wind farms.

FIG. 3A is a partially schematic, isometric illustration of a power transmitter 160 configured in accordance with an embodiment of the disclosure, and FIG. 3B is a partially schematic, cross-sectional illustration of the power transmitter 160, taken generally along line 3B-3B of FIG. 3A. Referring to FIGS. 3A and 3B together, the second portion 162 of the power transmitter 160 can include alternating current input leads 164 connected to primary windings 165 which are wound about an iron core 166. The core 166 includes a gap 169 that accommodates secondary windings 167 carried by the shaft 150. The secondary windings 167 can be mounted on a standoff 163 for positioning within the gap 169. The secondary windings 167 are connected to output leads 168 that provide power to the first processor 131 described above with reference to FIG. 2.

One feature of an embodiment of the power transmitter 160 described above is that it does not require direct physical/mechanical contact between stationary components carried by the nacelle 102 and moving components carried by the shaft 150. Accordingly, such embodiments are less susceptible to wear, tear and failure than those that require mechanical contact (e.g., a slip ring arrangement). Other power transmitters can achieve a similar result without a transformer. Such transmitters can include a rotary generator, a gyroscope carried by the shaft 150 and coupled to a generator (also carried by the shaft 150), or an arrangement of solar cells carried by the shaft 150 and a light source carried by the nacelle 102.

Another feature of a particular embodiment of the power transmitter 160 described above that includes a transformer is that the transformer does not require the shaft 150 to rotate in order to provide power to the shaft 150. Accordingly, the power transmitter 160 can provide power to the shaft 150 and sensors 120 whether the shaft 150 is rotating or stationary. Other embodiments of the power transmitter 160 (e.g., a generator or a solar cell) can include a rechargeable battery and/or capacitors on the shaft 150 to provide power to the sensors 120 when the shaft 150 does not rotate. In at least some of these embodiments (e.g., the gyroscope/generator combination) the entire unit can operate as a power source, can be carried by the shaft 150 (e.g., in a self-contained manner) and can have no physical contact with components off the shaft 150 while providing power that relies on the rotation of the shaft 150.

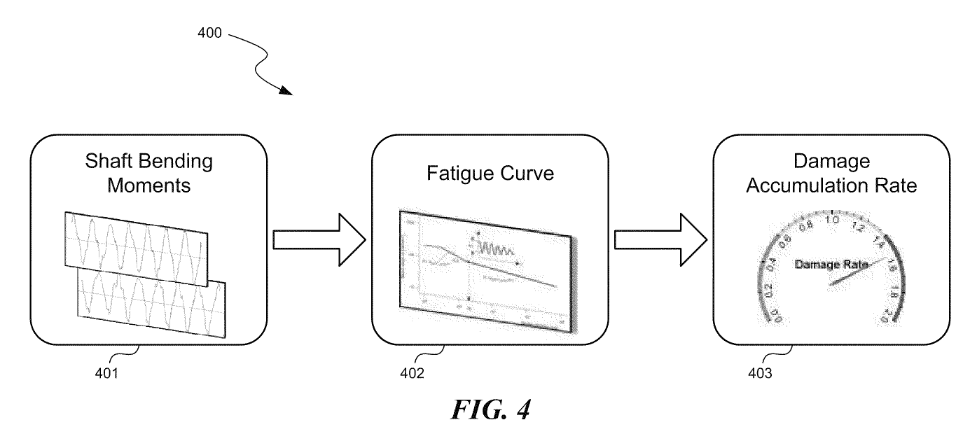

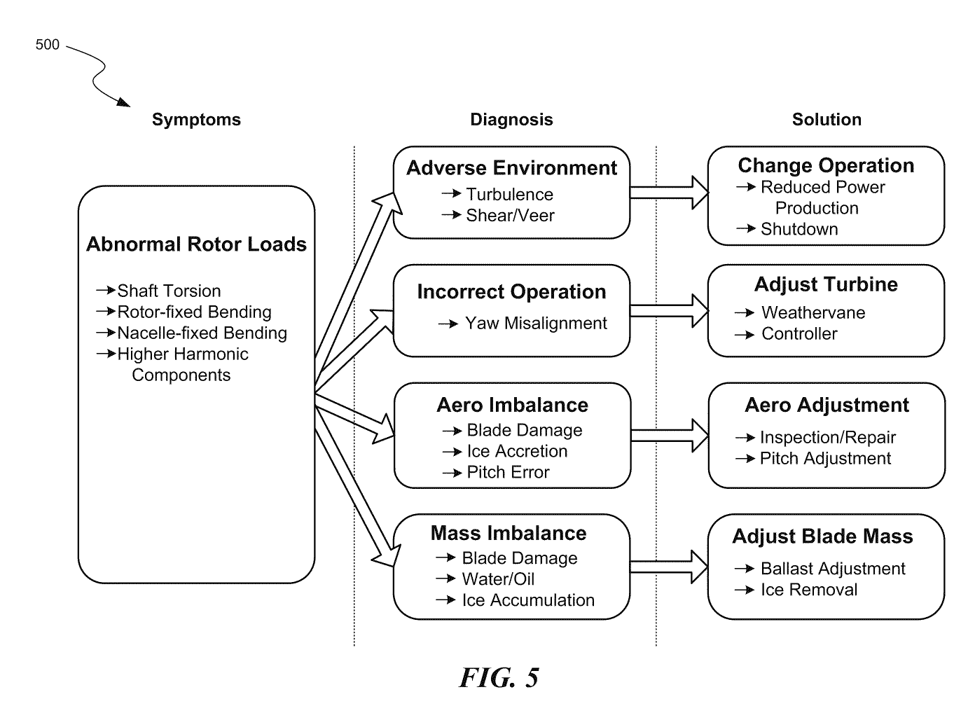

FIG. 4 illustrates a process 400 for handling information related to wind turbine system performance, in accordance with an embodiment of the disclosure. In block 401, the process includes measuring and transmitting sensor data corresponding to shaft bending moments. In block 402, the shaft bending moment data can be reduced, and can be combined with other information to provide reduced sensor data. In one aspect of this embodiment, the reduced data can take the form of a fatigue curve or exceedance curve. In other embodiments, the reduced data can be formatted in other manners. In block 403, the reduced data is synthesized to provide an indication of the damage accumulation rate and/or performance reduction rate. This information can be based on a number of inputs received from the wind turbine, and can include a projection of expected results based upon the compiled information. In addition to providing an indication of damage rate and/or performance loss, the system can automatically provide suggested steps by which the operator can correct the abnormalities resulting in an undesirable damage accumulation rate and/or performance loss, as described further below with reference to FIG. 5.

Referring now to FIG. 5, an overall process 500 can include identifying symptoms and/or causes corresponding to one or more abnormal loads, diagnosing the source of the symptoms, and providing one or more potential solutions for addressing the cause of the symptoms. The symptoms can include indications of an abnormal load, for example, an abnormal shaft bending moment, shaft shear, shaft axial load, and/or axial torsion. The source of these abnormal loads generally falls into one or more of three categories, identified in FIG. 5 as an adverse environment, incorrect operation, an aerodynamic imbalance, and a mass imbalance. The adverse environment can include turbulence, wind shear conditions (variable wind speed as a function of height), or veer conditions (variable wind direction as a function of height), and can typically be identified by changes in shaft bending movement that vary in an irregular or at least partly irregular manner. Lightning strikes and the aerodynamic and mass imbalances they can cause can also be part of the adverse environment. Incorrect operation can include a yaw misalignment. Aerodynamic imbalance can be caused by pitch misalignment, leading edge erosion (e.g., loss of material at the leading edge of the blades, including loss of stall strips), a lightning strike (which can also produce erosion at the blade surfaces) and/or surface accumulations (which can include ice, insects, and/or other debris). An aerodynamic imbalance and certain incorrect operations can often be distinguished from adverse wind environment effects because they will tend to be steady state rather than varying in an irregular or random manner. For example, a yaw imbalance (which results when the wind turbine blades are not properly pointed into the prevailing wind) can produce regularly varying eccentric forces on the wind turbine shaft, and can be corrected by realigning the nacelle relative to the wind direction. Wind direction can be obtained via a weathervane, or via more advanced techniques that detect wind characteristics upstream of the wind turbine. Such techniques include LIDAR and SODAR.

The diagnosis can also include identifying a mass imbalance, for example, an uneven mass distribution along the length of individual wind turbine blades. Such a mass distribution can result from ballast shifting, ice formation on the blade, the presence of water or oil that has seeped into the internal volume of the blade, or a lightning strike that is severe enough to cause a measurable mass loss in the blade. An uneven mass distribution can typically be distinguished from loads associated with an adverse wind environment and an aerodynamic imbalance because they vary cyclically in a predictable manner as the blades rotate, e.g., as the blades assume a different orientation with respect to the fixed gravity vector, and as the rotational speed and centrifugal forces change.

After diagnosing the foregoing deficiencies in an automated manner based on information received from the sensors described above with reference to FIG. 2, the system can automatically propose solutions that the operator can implement in order to correct the foregoing deficiencies. For example, when the diagnosis indicates an adverse wind environment, the proposed solution can include reducing the load on the wind turbine by changing the pitch angle of the wind turbine blades (e.g. feathering blades) or by shutting down the turbine in particularly detrimental circumstances. In a particular embodiment, the pitch of each blade can be changed as it rotates, to account for the elevation-correlated wind velocity differences associated with wind shear. The system can recommend a particular solution (or solutions) in a prioritized manner or other manner that reflects the likelihood of success for each solution given the current circumstances. In one embodiment, the operator retains discretion over implementing solutions. In another embodiment, some solutions may be implemented automatically (e.g., shutting down the wind turbine in particularly detrimental conditions).

If the diagnosis is an aerodynamic imbalance, the proposed solution typically starts with a visual inspection to identify potential blade damage. If no damage is visible, the solutions can include adjusting the pitch of individual blades relative to other blades, correcting a yaw misalignment (e.g., by adjusting the nacelle position, the nacelle position control law, and/or a weathervane or other wind direction indicator on the nacelle), cleaning the blades, performing surface repair on the blades, installing a stall strip on a particular blade, or installing vortex generators on the blade. The proposed solution can include identifying the particular blade or blades affected by the proposed solution, as well as a proposed location on the blade for implementing the solution. Similarly, if the diagnosis is an uneven mass distribution, the automatically proposed solution can include suggesting ice removal (e.g., if the temperature conditions and/or other environmental conditions likely support the formation of ice), and/or suggesting the placement of counterweights on one or more of the blades. Again, the solution can include the identity of the blades in need of a counterweight, the size of the counterweight, and a proposed location along the length of the blade at which the counterweight should be placed. The proposed solution can in some cases be implemented while the wind turbine is operating, e.g., if the solution is to change pitch and/or yaw angles. In such cases, the turbine can be adjusted manually by physically adjusting a weathervane, and/or automatically by providing a software change (e.g., an offset or an adjustment to a deadband zone) that is then implemented by a controller. In other embodiments, the solution can be implemented only when the wind turbine is shut down, e.g., during a maintenance procedure. In such instances, one portion of the solution (shutting the turbine down) can be implemented automatically, and another portion of the solution (e.g., adjusting the mass distribution along a blade) can be implemented manually. In any of these embodiments, the system can provide multiple proposed solutions, e.g., when it is not immediately clear which proposed solution will produce the best result. In such cases, the proposed solutions can be ranked in order of likelihood for success, ability to clearly eliminate one or more potential causes for the underlying problem, and/or other suitable criteria.

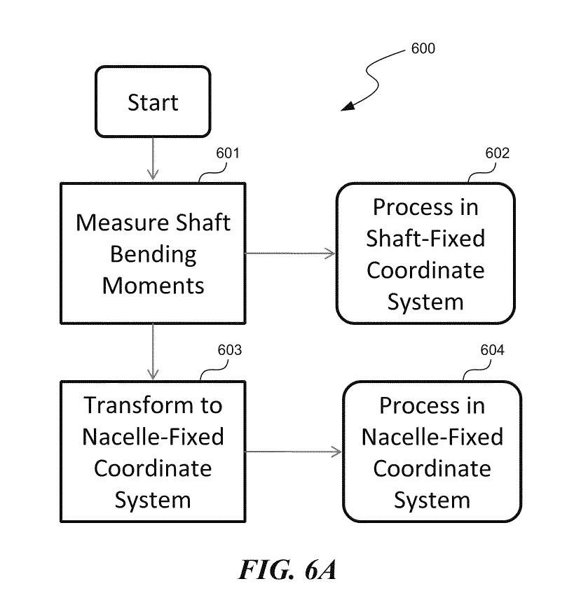

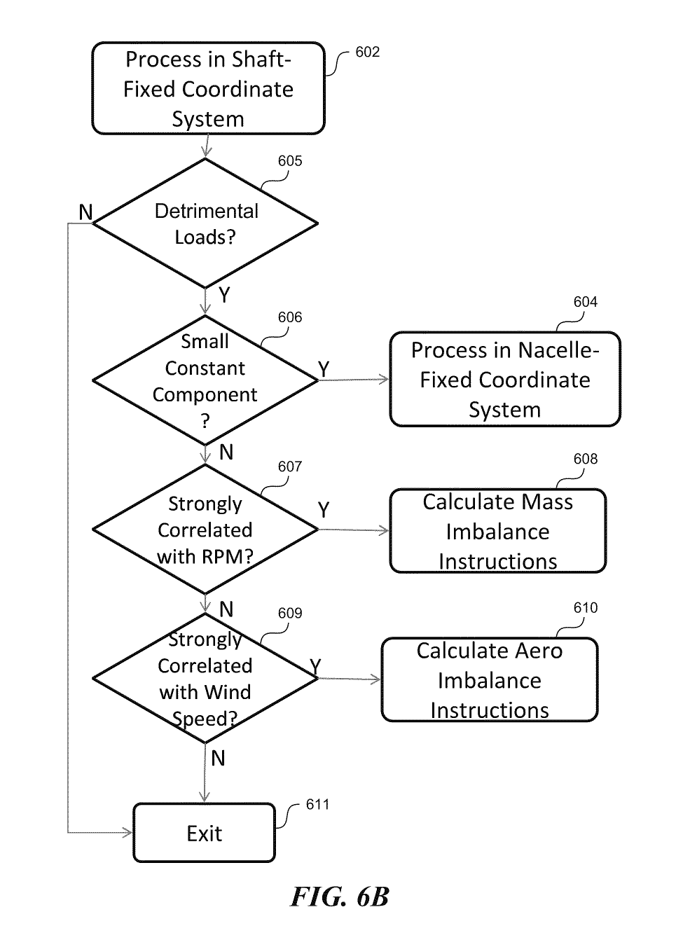

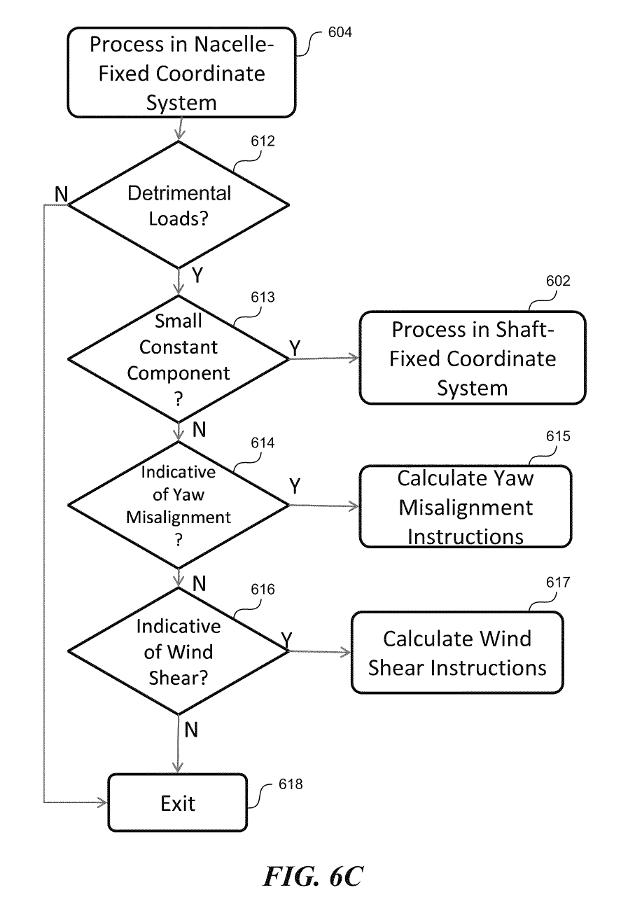

FIGS. 6A-6C illustrate a process for reducing measured data and producing the solutions and instructions described above with reference to FIG. 5. Beginning with FIG. 6A, the process 600 can include measuring shaft bending moments (block 601). Block 601 can in turn include collecting raw strain gauge data, determining bending moments from the data, and correcting the bending moment data for known quantities, for example, the force of gravity. Some or all of these calculations can be completed by the first processor 131 located on the shaft 150 described above with reference to FIG. 2. In block 602, the bending moment information is processed in a coordinate system that is fixed relative to the shaft, e.g., a coordinate system that rotates with the shaft. In block 603, the bending moment information is transformed to a nacelle-fixed coordinate system, and in block 604, the information in the nacelle-fixed coordinate system is processed. Bending moment signals that show large variations in one coordinate system may be relatively constant in the other coordinate system. Signals may be more easily analyzed for different types of symptoms in one coordinate system or the other. Further aspects of these algorithms are described below with reference to FIGS. 6B and 6C.

FIG. 6B illustrates further details associated with processing data in a shaft-fixed coordinate system (block 602). In block 605, the process includes determining whether the information identifies detrimental or otherwise abnormal loads. If not, the process exits at block 611. If so, then in block 606, the information is analyzed to determine whether it includes a large or small constant component, e.g., a constant component or offset that varies significantly or insignificantly as a function of time. If the constant component is small when analyzed in the shaft-fixed coordinate system, then the process shifts to analyzing the data in the nacelle-fixed coordinate system (block 604) described further below with reference to FIG. 6C. If the data have a relatively large and/or more variable component, then the data are likely to yield more significant results when analyzed in the shaft-fixed coordinate system. Accordingly, in block 607, the process determines whether the variation is strongly correlated with shaft RPM. If so, then it is expected that the variation results from a mass imbalance, and the process continues with calculating/determining instructions associated with correcting the mass imbalance (block 608). If instead, the variation is more strongly correlated with wind speed than with RPM (block 609) then it is expected that the variation is more likely associated with an aerodynamic imbalance. Accordingly, the process continues with calculating aerodynamic imbalance instructions to correct this variation (block 610). It is well understood that wind speed and RPM are correlated with each other. Accordingly, merely identifying a correlation with RPM and a correlation with the wind speed or power production may not be sufficient to determine whether the variation is caused by a mass imbalance or an aerodynamic imbalance. As a result, the foregoing process can include determining whether the variation is more strongly correlated with RPM or more strongly correlated with wind speed/power production.

FIG. 6C is a block diagram illustrating a process for analyzing data in the nacelle-fixed coordinate system (block 604). In block 612, the process determines whether detrimental or otherwise abnormal loads are encountered, and if not, the process exits at block 618. If detrimental loads are encountered, then in block 613, the process determines whether, in the nacelle-fixed coordinate system, the variation has a small constant component or a large/more variable profile. If the variation is a small constant component, then in block 602, the analysis shifts to the shaft-fixed coordinate system. If the constant component is relatively large and/or more variable, then the process moves to block 614 in which the information is analyzed to determine whether it is indicative of a yaw misalignment. A yaw misalignment refers generally to an improper yaw orientation of the nacelle 102 (FIG. 1) relative to, the prevailing wind direction. If the data indicate a yaw misalignment, then in block 615, the process calculates and displays yaw misalignment instructions. If not, the process includes analyzing the data for an indication of wind shear (block 616). Wind shear may be caused by the different wind velocities located close to the ground as compared with wind velocities located higher above the ground. Because the wind turbine blades have lengths on the order of 50 meters, the difference in wind velocity encountered by a blade tip at the bottom of its cycle can be significant when compared with the wind velocity encountered by a blade tip at the top of its cycle. This variation is expected to appear differently than a variation resulting from yaw misalignment. For example, yaw misalignment may be manifested by a purely sinusoidal variation, while wind shear variation may be associated with higher harmonics. In other embodiments, the distinguishing features may differ. For example, turbulence can be identified in either the nacelle-fixed coordinate system or the shaft-fixed coordinate system by a large random component in the load variation. In any of these embodiments, if the data indicate variations associated with wind shear, then the operator is provided with instructions on how to handle wind shear conditions producing detrimental loads (block 617).

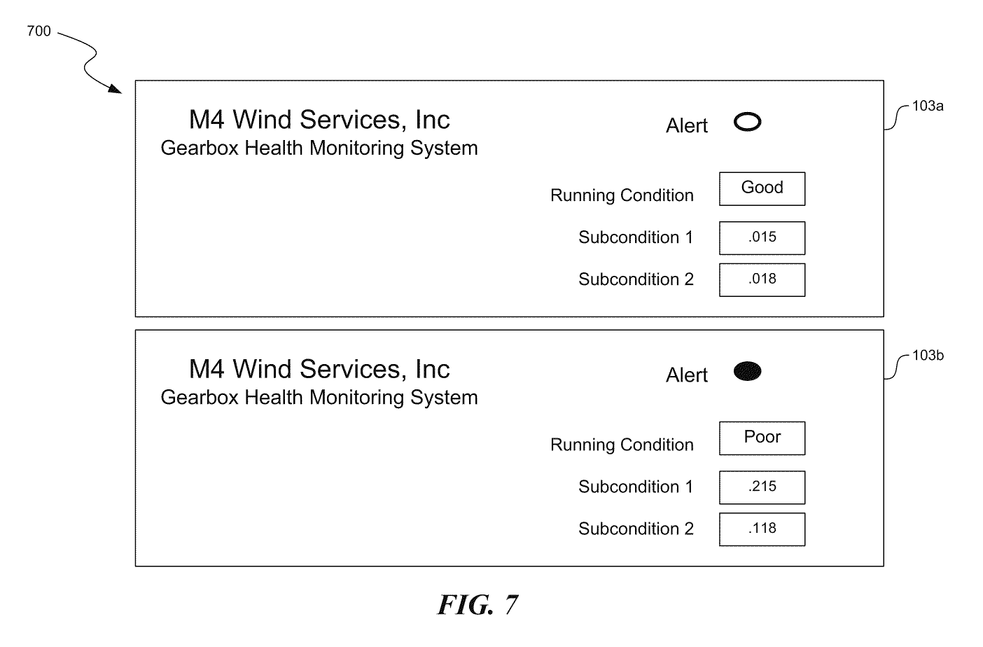

FIG. 7 illustrates a graphical user interface 700 identifying overall health values for two wind turbines in accordance with an embodiment of the disclosure. For wind turbine 103a, the overall running condition is identified as good, and an alert indicator is either blank or indicated in green or some other suitable notifier corresponding to a good running condition. No action is required on the part of the operator. In a particular embodiment, one or more selected sub-conditions (identified as sub-condition 1 and sub-condition 2) can be selected for display to the operator. As is also shown in FIG. 7, a second wind turbine 103b has a poor running condition, with an alert identifier darkened or indicated in red or another suitable manner so as to highlight an issue with that wind turbine. The alert can be annunciated at one or more locations (e.g., a central location, a wind farm location, and/or at the wind turbine itself) via one or more modes (e.g., visual, aural or otherwise). Values for selected sub-conditions can also be displayed to give the operator an initial sense of the source for the poor running condition. The operator can then call up an additional display or menu that provides further information, for example, the diagnosis and solution information described above with reference to FIG. 5.

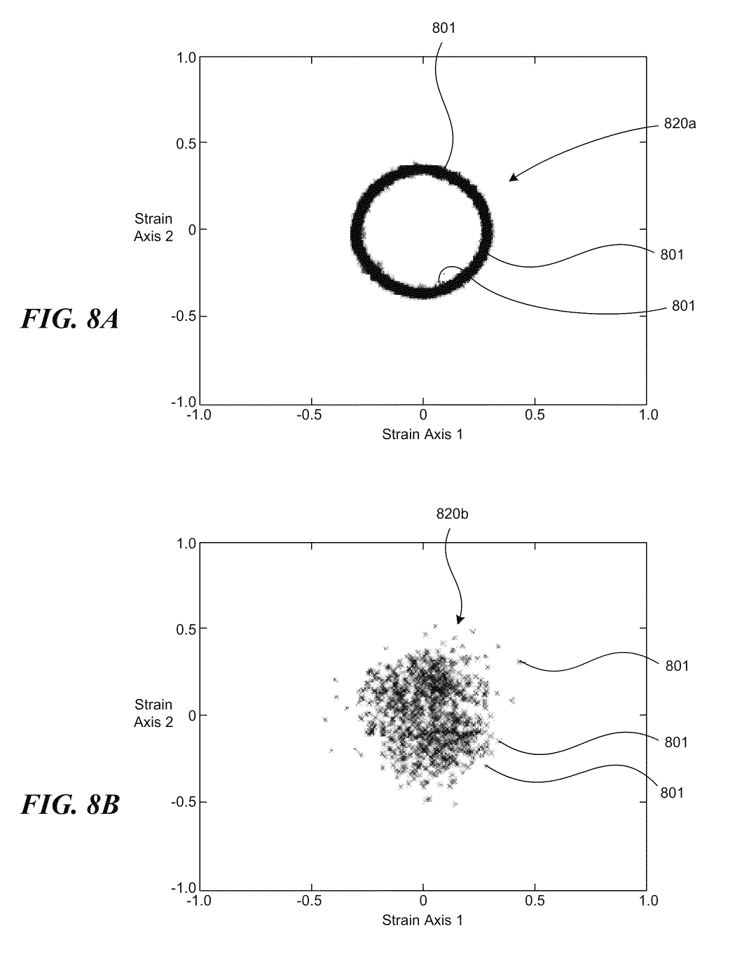

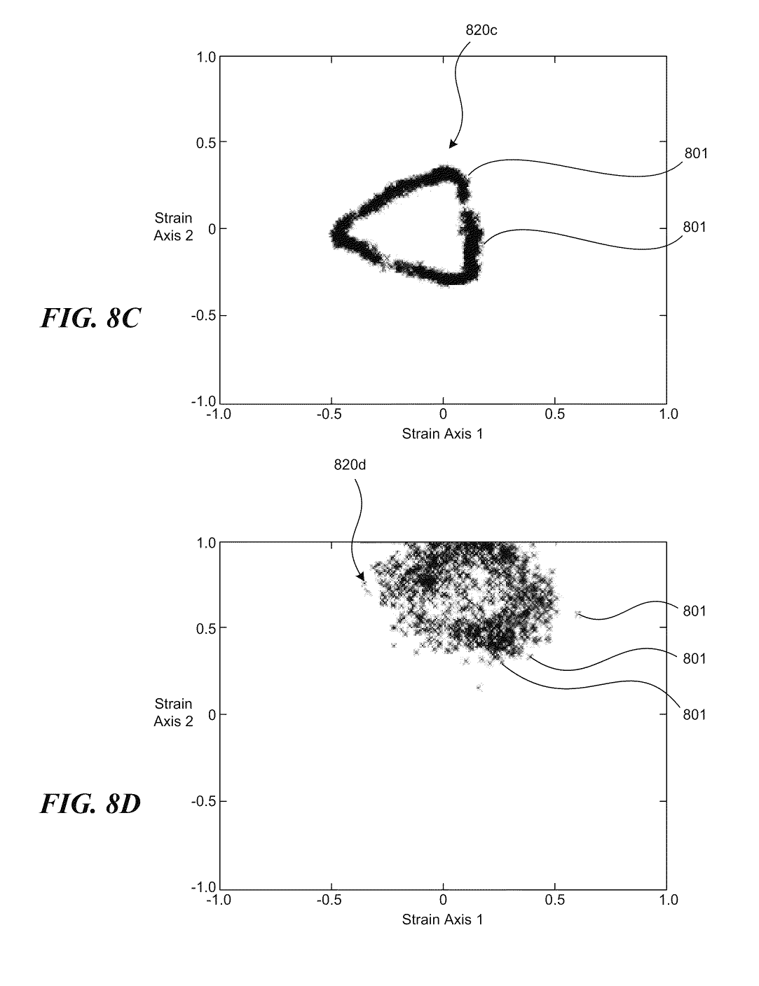

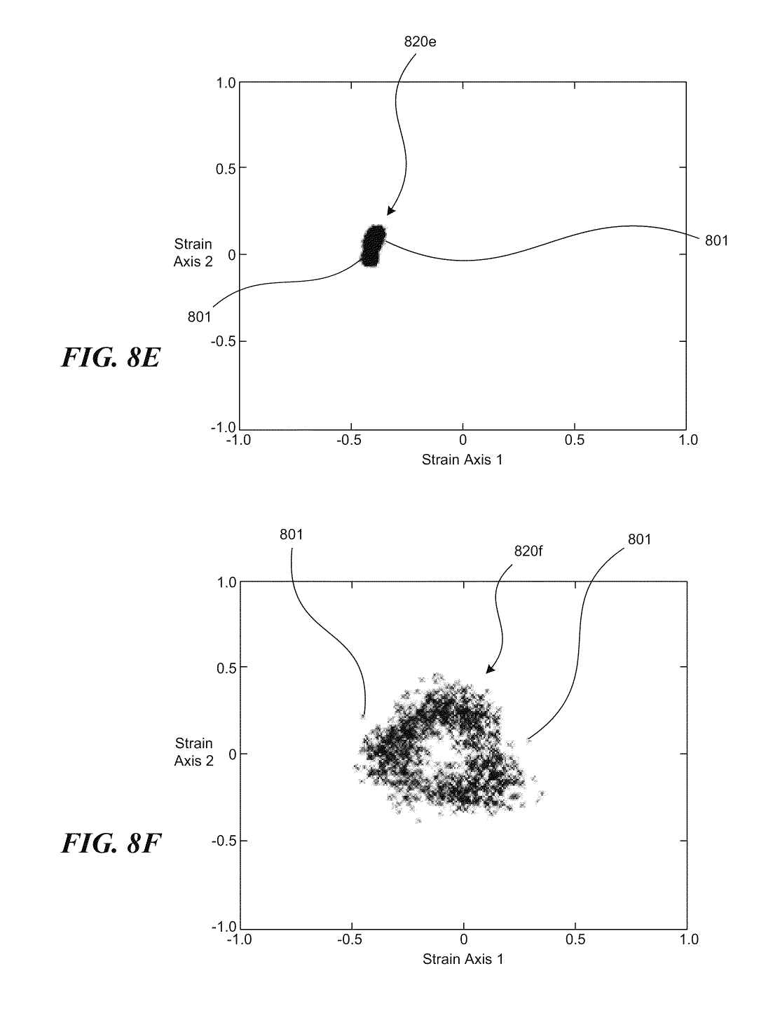

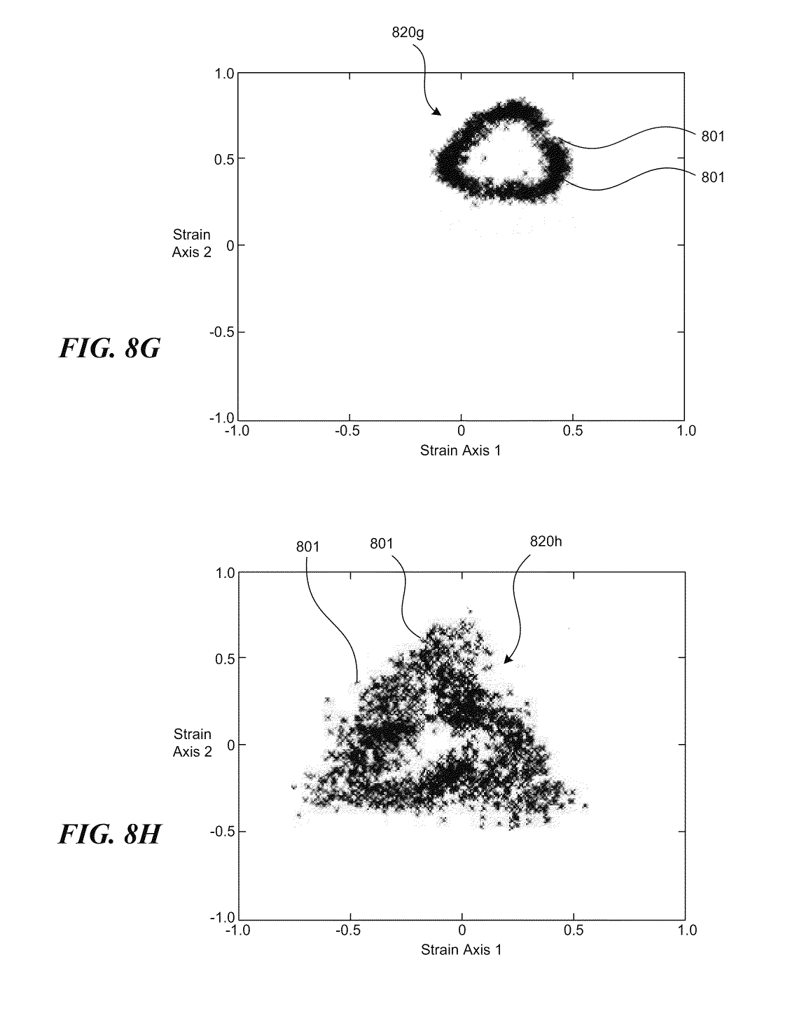

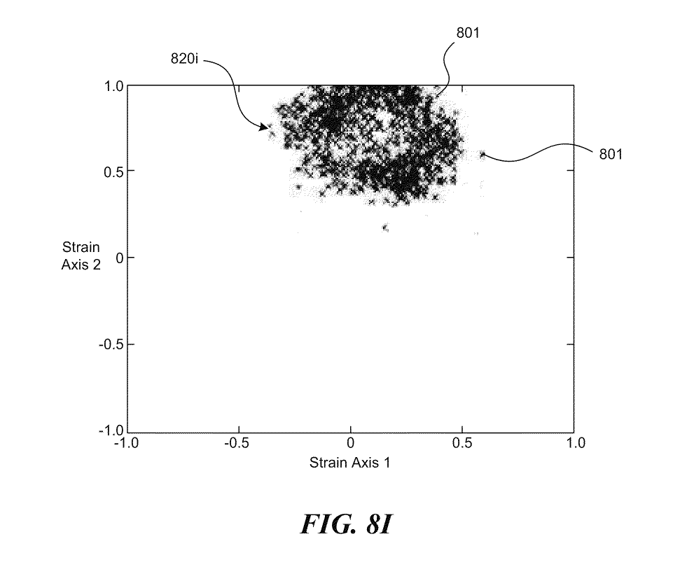

FIGS. 8A-8I are graphical illustrations of results obtained using systems (e.g., live load diagnostic systems) generally similar to those described above, in accordance with particular embodiments of the present disclosure. These Figures illustrate that the data obtained from sensors mounted to the wind turbine shaft can have patterns that indicate, are correlated with, and/or otherwise correspond to performance characteristics of the wind turbine in which the shaft is mounted. The patterns are clearly visible to a human observer when presented graphically, but can also be identified, processed, and/or interpreted (e.g., by a suitable computer program) when in numerical format. The data can be used in various manners. For example, an operator can view the graphically presented data, interpret the data, and make adjustments to the operation of the wind turbine and/or the maintenance schedule for the wind turbine based on the data. In other embodiments, some or all of the foregoing operations can be automated to reduce the workload on the operator and/or increase the reliability and/or consistency of the actions taken in response to the data. For example, the system can automatically correlate the information presented by the data with operating conditions of the wind turbine, and, as discussed above, provide suggestions or recommendations for responding to the data in a manner that increases the operating efficiency, and/or reduces the loads on the turbine. In other embodiments, this process can be further automated. For example, the system can automatically implement the proposed responses. In a particular example, the system can automatically shut down the wind turbine when loads exceed particular limits. In other embodiments, operational characteristics of the wind turbine (e.g., turbine yaw angle and/or blade pitch angle) are automatically adjusted to reduce loads on the wind turbine and/or increase the efficiency with which the wind turbine converts wind energy to electrical energy.

FIG. 8A is a graph of the non-dimensionalized strain at the surface of the turbine shaft 150 (FIG. 2) along a first strain axis 1 as a function of another variable. In a particular embodiment, the other variable includes the non-dimensionalized strain along a second strain axis 2. The two strain axes can be orthogonal, e.g., with both axes in a plane transverse to (e.g., perpendicular to) the rotation axis of the shaft, and with one axis oriented along the 12:00-6:00 direction, and with the other axis oriented along the 3:00-9:00 direction. In an embodiment shown in FIG. 8A, data points 801 (represented by small x's) indicate the strain values measured by a representative four of the strain gauges 121 shown in FIG. 2 (e.g., strain gauges 121e-121h). Each data point 801 represents the strain measured by one strain gauge at one moment in time. The data can be obtained at a suitable rate (e.g., 25 Hz) that is selected based at least in part on the rate at which the strain values are expected to change. The data for an elapsed period of time are then presented together. For example, FIGS. 8A-8I each illustrate ten minutes of data. As shown in FIG. 8A, the data points 801 can form a first shape 820a, for example, a ring shape. In this embodiment, the data points 801 are tightly distributed to form the first shape 820a. The first shape 820a is representative of a wind turbine operating properly under good environmental conditions. For example, the first shape 820a can be produced when the shaft is rotating at a standard or baseline rotation rate, with moderate winds, and with no detrimental turbulence or wind shear. In addition, the wind turbine blades are properly directed (in pitch and yaw) into the wind stream. This operating condition is accordingly representative of one that is associated with suitable levels of power production and low levels of wear on the turbine, bearings, gear box, and generator. As will be discussed further below, the shape can change in regular, easily-recognizable manners when conditions depart from those described above.

FIG. 8B is a graph illustrating data points 801 forming a second shape 820b, generally characterized as a cloud of points. The second shape 820b is associated with turbulent wind conditions, and produces an irregular strain variation on the turbine shaft. This in turn produces irregular loads on other system components (e.g., the main bearing, gearbox and generator) which in turn produces high wear rates on the system components. Accordingly, the operator (manually and/or via an automatically implemented process), can make adjustments to the wind turbine when the turbine encounters conditions producing the second shape 820b. One such adjustment is to slow down or shut down the turbine until the turbulence abates.

FIG. 8C illustrates data points 801 producing a third shape 820c, indicating a different set of environmental conditions. In particular, the third shape 820c (which is generally a triangular frame shape) is associated with wind shear, e.g., different wind speeds at different heights above the ground. The result of the wind shear is that the strain on each blade changes significantly when the blade encounters areas of different wind velocity or direction at different heights. The triangular shape shown in FIG. 8C is associated with a three-bladed wind turbine, and accordingly, this shape can be different in other embodiments for which the wind turbine has a different number of blades. In any of these embodiments, the response (automatic or manual) to data corresponding to the third shape 820c can be to alter the pitch of each blade while on its upward trajectory.

FIG. 8D illustrates a fourth shape 820d that is associated with rotor imbalance. The shape 820d is generally characterized as an off-center cloud of points. Accordingly, it can resemble the cloud of points shown in FIG. 8B (which is associated with turbulence), but is off-center relative to the origin of one or both of the strain axes. Rotor imbalance can produce damage to the main bearing and/or the gear box, and is accordingly a condition that operators wish to avoid.

Rotor imbalance can be caused by a mass imbalance and/or an aerodynamic imbalance. A mass imbalance is generally associated with one blade being heavier or lighter than another, and an aerodynamic balance is generally associated with one blade generating too much lift or too little lift, as a result of blade damage, improper pitch, free play in the pitch mechanism, or another condition. The effect of a mass imbalance is expected to be proportional to the square of the shaft RPM. Accordingly, this effect changes rapidly with changes in RPM, and does not change significantly with other operational conditions. Conversely, effects associated with aerodynamic imbalance are expected to be proportional to generator power or wind speed, and can show significant changes even when RPM is relatively constant. As a result, one technique associated with the present disclosure is to distinguish between mass imbalance and aerodynamic imbalance based on the strain sensitivity to RPM. This information can be obtained by correlating the strain data shown in FIG. 8D with RPM and/or with generator power to determine which has the stronger correlation. By obtaining this information, the operator can readily understand which effect to address, and can understand whether the effect can be addressed “on the fly” or during a maintenance procedure. For example, if the imbalance is an aerodynamic imbalance, the operator (automatically or manually) can adjust the pitch of one or more of the blades while the turbine is operating. Because pitch is a potential contributing factor to an aerodynamic imbalance (but not a mass imbalance) the operator can make this adjustment with a reasonable likelihood of success. Conversely, the operator need not waste time adjusting the blade pitch angle when the data indicate a mass imbalance, and can instead focus efforts on identifying a suitable maintenance period during which to correct the mass imbalance while the wind turbine is offline.

FIG. 8E illustrates a fifth shape 820e associated with a non-operational turbine, e.g., one for which the rotor shaft is not spinning. Accordingly, the fifth shape 820e tends to be a tightly formed cluster of data points that does not change significantly over time.

In many cases, wind turbines may experience various combinations of the operational factors described above. As demonstrated by the following Figures, the data can produce associated predictable shapes that correspond to combinations of the shapes described above. For example, FIG. 8F illustrates data points 801 producing a sixth shape 820f associated with the combination of turbulence and wind shear. The shape is a combination of the triangular shape described above with reference to FIG. 8C, and the cloud shape described above with reference to FIG. 8B. FIG. 8G illustrates a seventh shape 820g generally characterized as an off-set triangle. The seventh shape 820g is associated with wind shear in combination with a shaft imbalance, (e.g., a combination of the shape shown in FIG. 8C and the shape shown in FIG. 8D).

FIG. 8H illustrates an eighth shape 820h associated with the combination of shaft imbalance, turbulence, and wind shear.

FIG. 8I illustrates a ninth shape 820i associated with the combination of turbine shaft imbalance and turbulence.

As discussed above, the response to identifying any of the foregoing shapes (and/or the numerical distributions that form the bases of the shapes) can be manual, automated, or semi-automated, depending on the particular embodiment. In one embodiment, the operator views graphical data presented at a computer monitor, and takes manual action in response. Such an action can include iteratively changing conditions (e.g., blade pitch or yaw) while observing the direct effect on the computer monitor in a feedback manner. Accordingly, the operator can obtain live feedback as he or she adjusts the turbine conditions. In a particular example, the data presented to the operator can be reduced from the shapes described above to a simple green-yellow-red color coded indication of the wind turbine operation characteristics. In a further particular example, the color coded arrangement can be presented in the manner of a gauge, for example, as shown in FIG. 4.

In another embodiment, the foregoing process can be automated. For example, the data need not be actually presented at a monitor, but can instead be interpreted by an appropriate program and automatically compared with existing patterns or numerical correlates of such patterns to identify which pattern it most closely corresponds to. This process can be used to distinguish between the circular frame or ring shape shown in FIG. 8A and the triangular frame or ring shape shown in FIG. 8C. This process can also be used to distinguish between the tightly formed shapes shown in FIGS. 8A and 8C, and the more loosely distributed clusters shown in FIGS. 8B and 8D. For example, the process can include calculating a measure of deviation (e.g., a standard deviation) of the data relative to a standard pattern or shape. Still further, this process can be used to distinguish among the shapes associated with combinations of factors, described above with reference to FIGS. 8F-8I. Once the appropriate shape is identified, the program can automatically issue instructions for response. As discussed above, these instructions can include, but are not limited to, varying the blade pitch angle, varying the yaw angle, slowing the turbine, and/or stopping the turbine. As discussed above, this methodology can include an automated feedback loop to enhance the speed with which the system identifies an improved (e.g., optimal) solution. In any of these embodiments, the operator can manually override the system at any point, and the system can automatically request operator input at any point via a suitable alert.

One feature of at least some of the foregoing embodiments is that the system can be relatively simple to implement and can accordingly have a relatively low installation cost and maintenance cost. For example, the additional sensors used to implement the diagnosis and analysis provided by the system can be installed solely on the shaft of the wind turbine, via a standard, easy to apply adhesive. This arrangement reduces the need to add sensors to a variety of wind turbine components. Power for the sensors and data reduction facilities associated with the sensors can be provided via a low cost, robust wireless and battery-less system, such as that described above with reference to FIG. 3. Accordingly, the costs associated with maintaining the system once installed can be relatively low.

Another feature of at least some of the foregoing embodiments is that the addition of a limited number of sensors can produce a large amount of valuable information. For example, in a particular embodiment, only 6-8 strain gauges are installed on the wind turbine shaft, and are supplemented by a bi-axial accelerometer. The data obtained from this relatively small number of sensors can be used to diagnose a wide variety of potential problems typically associated with wind turbine degradation. For example, this information can be used to identify mass imbalances that would otherwise adversely affect the wind turbine gear box, well in advance of the gear box incurring damage that might require it to be replaced or repaired. The information corresponding to multiple operational parameters and/or characteristics can also be synthesized to produce an overall state or status (e.g., indicating that the turbine is operating well, fairly well or poorly).

Still another feature of at least some of the foregoing embodiments is that one or more proposed solutions to an identified problem are presented in a manner that is straightforward and simple to understand. Accordingly, the wind turbine operator need not sift through a large amount of information to identify either what the problem is or what the solution is, and can instead proceed directly to implementing a solution that is automatically provided in sufficient detail.

Yet another feature of at least some of the foregoing embodiments is that they can include presenting and/or automatically reducing the data obtained from the rotor shaft in a manner that readily distinguishes among different types of factors that may produce sub-optimum conditions at the turbine. Such conditions can include conditions that reduce the efficiency with which the turbine produces energy, and/or conditions that produce higher than desired wear on the turbine.

Any of the foregoing features can provide useful information to the operator during one or more phases of the wind turbine operation. For example, any of the foregoing methods can be used for a well-established turbine to enhance efficiency and/or reduce component wear. These processes may also be used when a wind turbine is initially installed to troubleshoot installation issues, and/or can be used after routine maintenance processes to confirm that the maintenance has been properly conducted, and/or identify issues associated with the maintenance procedure.

In still further embodiments, the foregoing data can be used in a “smart system” arrangement. For example, the information can be collected over the course of time and correlated in order to more quickly identify solutions when particular conditions are encountered during subsequent operations. In a particular example, if the system initially determines that a particular wind turbine has a particular (e.g., optimum) yaw setting and blade pitch setting when the prevailing winds are at a compass setting of 300° and a speed of 20 mph, the system can immediately tune the wind turbine to the appropriate pitch and yaw settings the next time the same combination of environmental conditions is encountered.

From the foregoing, it will be appreciated that specific embodiments of the disclosure have been described herein for purposes of illustration, but that various modifications may be made without deviating from the disclosure. For example, the disclosed sensors may have different arrangements and/or configurations in other embodiments. The power transmitter used to provide power to shaft-mounted components of the system can have arrangements other than a transformer, e.g., a gyroscope arrangement, a piezoelectric arrangement, or a photocell arrangement. The data received from the sensors can be presented in the form of strain or a bending moment as a function of a variable other than the strain or bending moment along the second axis. For example, the data can be organized in the form of two polar plots: one presents strain along the first strain axis as a function of circumferential location around the shaft, and the other presents strain along the second strain axis also as a function of circumferential location around the shaft. In other embodiments, the data can be organized in still other manners that allow the source of imbalance or other adverse conditions to be readily identified.

Certain aspects of the disclosure described in the context of particular embodiments may be combined or eliminated in other embodiments. Further, while advantages associated with certain embodiments have been described in the context of those embodiments, other embodiments may also include such advantages, and not all embodiments need necessarily exhibit such advantages to fall within the scope of the present disclosure. Accordingly, the disclosure can encompass other embodiments not expressly shown or described herein

I/We claim:

1. A wind turbine system, comprising
a wind turbine shaft;
at least one sensor carried by the wind turbine shaft; and
a power transmitter operatively coupled to the at least one sensor, the power transmitter having a first component carried by the wind turbine shaft and a second component off the wind turbine shaft, the second component being positioned to transmit power to the first component while the wind turbine shaft rotates, without contacting the first component.

2. The system of claim 1 wherein the power transmitter includes a transformer, and wherein the first component includes a secondary transformer winding and the second component includes a primary transformer winding.

3. The system of claim 1 wherein the power transmitter includes a rotary electrical power generator.

4. The system of claim 1 wherein the first component rotates with the shaft as the shaft rotates, and wherein the second component does not rotate with the shaft.

5. The system of claim 1 wherein the sensor includes a strain gauge.

6. The system of claim 1, further comprising a processor operatively coupled to the at least one sensor to receive and process signals from the at least one sensor, the processor including an analysis component containing instructions that, when executed perform at least one of the following processes:
diagnose an adverse condition; and
identify a load remediation solution for reducing, redistributing, or both reducing and redistributing a load on the wind turbine shaft, based at least in part on the signals received from the at least one sensor.

7. The system of claim wherein 6 at least a portion of the processor is carried by the turbine shaft.

8. The system of claim 7 wherein a portion of the processor carried by the shaft includes instructions for reducing a bandwidth of information transmitted away from the shaft.

9. A wind turbine system, comprising
a wind turbine shaft;
at least one sensor carried by the wind turbine shaft; and
a power source carried by the shaft and operatively coupled to the at least one sensor, the power source having no mechanical contact with components off the shaft and having at least one element that produces power in a manner that requires the wind turbine shaft to rotate.

10. The wind turbine system of claim 9 wherein the power source has a first component carried by the wind turbine shaft and a second component off the wind turbine shaft, the second component being out of mechanical contact with the first component, the first and second components together producing power when the wind turbine shaft rotates.

11. The wind turbine system of claim 10 wherein the power source includes an electric generator and wherein the first component is a rotary portion of the generator and the second component is a stationary portion of the generator.

12. The wind turbine system of claim 9 wherein the power source includes a gyroscope carried by the wind turbine shaft and an electric generator coupled to the gyroscope to convert mechanical energy produced by the gyroscope when the wind turbine shaft rotates to electrical energy.

13. A wind turbine system, comprising
a wind turbine shaft;
at least one sensor carried by the wind turbine shaft; and
a processor operatively coupled to the at least one sensor, the processor being programmed with instructions that, when executed, receive and process signals from the at least one sensor, the processor being carried by and rotatable with the wind turbine shaft

14. The system of claim 13 wherein the instructions, when executed, convert the signals received from the at least one sensor to data in the form of engineering units.

15. The system of claim 14 wherein the at least one sensor includes a plurality of strain gauges and wherein the instructions, when executed, convert raw signal data from the strain gauges to a bending moment value.

16. The system of claim 14 wherein the at least one sensor includes a plurality of strain gauges and wherein the instructions, when executed, convert raw signal data from the strain gauges to a torsion value.

17. The system of claim 13 wherein the instructions, when executed, perform a mathematical operation on signals received from the at least one sensor.

18. The system of claim 13 wherein the instructions, when executed, receive signals having a first bandwidth from the at least one sensor and convert the signals to data having a second bandwidth less than the first bandwidth before the data are transmitted off the shaft.

19. The system of claim 13 wherein the processor is a first processor, and wherein the system further comprises a second processor located off the shaft and not rotatable with the shaft, the second processor being in wireless communication with the first processor to receive processed signals from the first processor.

20. A method for operating a wind turbine, comprising:
automatically receiving information from a sensor carried by a shaft of the wind turbine, the shaft carrying at least one wind turbine blade;
automatically analyzing the information with a processor; and
based on results of analyzing the information, automatically presenting an operator-implementable recommendation for a subsequent action.

21. The method of claim 20, further comprising automatically implementing at least part of the recommendation for a subsequent action.

22. The method of claim 21 wherein automatically implementing at least part of the recommendation includes automatically shutting the wind turbine down or reducing power production.

23. The method of claim 20 wherein the recommendation includes a maintenance recommendation.

24. The method of claim 20 wherein the recommendation includes a maintenance recommendation to be implemented when the wind turbine is not actively generating electrical power.

25. The method of claim 20 wherein the recommendation includes a plurality of recommendations ranked in order of likelihood for success.

26. The method of claim 20 wherein the recommendation includes a recommendation for an action other than slowing or stopping the wind turbine.

27. The method of claim 20 wherein the recommendation includes a recommendation for a mass adjustment of the at least one wind turbine blade, the mass adjustment including both a magnitude of the adjustment and a location on the blade for the adjustment.

28. The method of claim 20 wherein the recommendation includes a recommendation for a aerodynamic pitch adjustment of the at least one wind turbine blade, the aerodynamic adjustment including blade identification and magnitude of pitch adjustment.

29. The method of claim 20, further comprising:
distinguishing between a load imbalance caused primarily by an asymmetric aerodynamic load, and a load imbalance caused primarily by an asymmetric mass load;
presenting a first recommendation if the load imbalance is caused primarily by an asymmetric aerodynamic load; and
presenting a second recommendation if the load imbalance is caused primarily by an asymmetric mass load.

30. The method of claim 29 wherein distinguishing includes:
determining a first correlation between the rotational speed of the wind turbine and an asymmetric load;
determining a second correlation between wind speed or power produced by the wind turbine and an asymmetric load;
identifying the load imbalance as caused primarily by an asymmetric mass load when the asymmetric load is more strongly correlated with wind speed or power production than with rotation rate; and
identifying the load imbalance as caused primarily by an asymmetric mass load when the asymmetric load is more strongly correlated with rotation rate than with power or wind speed.

31. The method of claim 20 wherein presenting a recommendation includes presenting a recommendation that reduces wear on a wind turbine generator coupled to the shaft.

32. The method of claim 20 wherein presenting a recommendation includes presenting a recommendation that reduces wear on a gear train coupled between the shaft and a wind turbine generator.

33. The method of claim 20 wherein automatically analyzing includes automatically determining a damage accumulation rate based at least in part on the information.

34. The method of claim 20 wherein automatically analyzing includes automatically determining a performance reduction rate based at least in part on the information.

35. A system for providing wind turbine status information, comprising:
a plurality of sensors carried by a wind turbine shaft;
a processor operatively coupled to the plurality of sensors, the processor being programmed with instructions that, when executed:
automatically synthesize information from the plurality of sensors; and
automatically present a status indicator corresponding to a status of the wind turbine based at least in part on the synthesized information.

36. The system of claim 35 wherein the status indicator is visual indicator, and wherein the status indicator is presented in a color representative of the status of the wind turbine.

37. The system of claim 35 wherein the status indicator is visual indicator, and wherein the status indicator is a computer-based icon in the form of an analog gauge.

38. The system of claim 35 wherein the plurality of sensors includes multiple strain gauges.

39. The system of claim 35 wherein the plurality of sensors includes an accelerometer.

40. The system of claim 35, further comprising at least one sensor not carried by the wind turbine shaft.

41. The system of claim 40 wherein the at least one sensor includes an anemometer.

42. The system of claim 35 wherein the instructions, when executed, automatically synthesize data from at least one strain gauge and at least one accelerometer.

43. A method for monitoring a wind turbine, comprising:
receiving sensor data from at least one strain gauge located on a wind turbine shaft;
organizing the data to indicate strain along a first axis as a function of another variable;
comparing the data to at least one reference pattern of data;
based on a degree of correlation between the data and the at least one reference pattern, identifying an operational state of the wind turbine.

44. The method of claim 43 wherein the other variable is strain along a second axis.

45. The method of claim 43, further comprising automatically identifying a change for an operational characteristic of the wind turbine based at least in part on the operational state of the wind turbine.

46. The method of claim 43, further comprising distinguishing between a mass imbalance and an aerodynamic imbalance.

47. The method of claim 43 wherein comparing the data includes comparing data received from multiple strain gauges at multiple points in time to a reference pattern for multiple strain gauges at multiple points in time.

48. The method of claim 43 wherein the reference pattern includes a generally elliptical ring corresponding to a normal operating state.

49. The method of claim 43 wherein the reference pattern includes a generally triangular ring corresponding to operation in a wind shear condition.

50. The method of claim 43 wherein the reference pattern includes a generally amorphous cloud of points corresponding to operating in wind turbulence.

51. The method of claim 43 wherein the reference pattern is eccentric relative to the first and second axes, and wherein identifying an operational state includes identifying the turbine as operating with a rotor imbalance.

52. The method of claim 43 wherein the reference pattern is one of multiple reference patterns, and wherein comparing includes comparing to the multiple reference patterns and determining a degree of correlation with each of the multiple reference patterns, and wherein identifying an operational state includes identifying an operational state corresponding to the pattern having the greatest degree of correlation.

53. The method of claim 43, further comprising determining the operational state to be a composite of operational states based on correlations with multiple patterns.

54. The method of claim 43, further comprising:
automatically changing one or more operating parameters of the wind turbine based at least in part on the identified operational state;
receiving updated sensor data from the at least one strain gauge after changing the one or more operating parameters;
organizing the updated data to indicate strain along the first axis as a function of strain along a second axis;
comparing the updated data to at the least one reference pattern of data;
based on a degree of correlation between the updated data and the at least one reference pattern, determining whether or not to change any operational parameters of the wind turbine.

55. A system for monitoring a wind turbine, comprising:
at least one strain gauge positionable on a wind turbine shaft; and
a processor operatively coupled to the strain gauge and programmed with instructions that, when executed:
organize data received from the at least one strain gauge to indicate strain along a first axis as a function of another variable;
compare the data to at least one reference pattern of data; and
based on a degree of correlation between the data and the at least one reference pattern, identify an operational state of the wind turbine.

56. The system of claim 55 wherein the other variable is strain along a second axis.

57. The system of claim 55 wherein the instructions, when executed, automatically identify a change for an operational characteristic of the wind turbine based at least in part on the operational state of the wind turbine.

58. The system of claim 57 wherein the reference pattern is one of multiple reference patterns, and wherein comparing includes comparing to the multiple reference patterns and determining a degree of correlation with each of the multiple reference patterns, and wherein identifying an operational state includes identifying an operational state corresponding to the pattern having the greatest degree of correlation.

59. A system for operating a wind turbine, comprising:
at least one sensor positioned to sense a characteristic of a wind turbine, an environment in which the wind turbine operates, or both the wind turbine and the environment; and
a processor operatively coupled to the at least one sensor and programmed with instructions that, when executed:
in response to a first occurrence of the characteristic, correlate the characteristic with a first operational setting of the wind turbine; and
in response to a second occurrence of the characteristic, subsequent to the first occurrence, automatically direct the wind turbine to a second operational setting at least approximately identical to the first operational setting.

60. The system of claim 59 wherein the first operational setting of the wind turbine is a setting to which the wind turbine is directed in response to the first occurrence of the characteristic.

61. The system of claim 59 wherein the first operational setting of the wind turbine is a setting in which the wind turbine was when the first occurrence of the characteristic occurred.

62. The system of claim 59 wherein the first occurrence of the characteristic includes a wind speed and direction, and wherein the first setting includes at least one of a yaw orientation of the wind turbine and a pitch orientation of wind turbine blades.

63. The system of claim 59 wherein the first occurrence of the characteristic includes a diagnosed adverse condition, and wherein the first setting includes at least one of a yaw orientation of the wind turbine and a pitch orientation of wind turbine blades.
